(19) United States
(12) Patent Application Publication
(10) Pub. No.: US 2026/0225397 A1
(43) Pub. Date: Aug. 6, 2026

(54) A FOIL, A DECORATIVE PRINTED FOIL, ROLL OF SUCH FOIL AND A METHOD FOR MANUFACTURING SAID FOIL AND/OR ROLL

(71) Applicant: Unilin, BV, Wielsbeke (BE)

(72) Inventors: Laurent MEERSSEMAN, Wielsbeke (BE); Benjamin CLEMENT, Wielsbeke (BE)

(73) Assignee: Unilin, BV, Wielsbeke (BE)

(21) Appl. No.: 19/152,830

(22) PCT Filed: Feb. 8, 2024
(86) PCT No.: PCT/IB2024/051148

§ 371 Date: Jul. 31, 2025

Related U.S. Application Data
(60) Provisional application No. 63/446,448, filed on Feb. 17, 2023.

(51) Int. Cl. B44C 1/10; B44C 1/24; B44C 5/04

(52) U.S. Cl. CPC B44C 1/10; B44C 1/24; B44C 5/04

(57) ABSTRACT

A foil may provide a base foil of a decorative printed foil. The foil may be a thermoplastic foil. The foil may have a first main surface for carrying a decorative print, and a second main surface opposite to the first main surface. At least one of the first and the second main surfaces may be provided with embossments.

This application claims priority under 35 USC § 119(e) from U.S. Provisional Patent Application No. 63/446,448 filed Feb. 17, 2023, the entire contents of which are incorporated herein by reference.

### BACKGROUND

### 1. Field

The present invention relates to foils, decorative printed foils and rolls of such foils.

### 2. Related Art

Printable and printed foils are known for use in e.g. decorative panels such as floor panels. Particularly with panels comprising a substrate based on a plastic material, or filled plastic material, such decorative printed foil may be applied as part of a decorative top layer applied on top of said substrate. For example, the substrate may comprise polyvinylchloride (PVC) or another thermoplastic material, such as polypropylene (PP) and/or polyethylene (PE), and/or may comprise polyurethane (PU). As a filler material in each of these materials chalk, limestone, talc or other inorganic materials may be applied, as well as organic materials such as rice husk and/or wood particles and/or bamboo particles.

The printable or printed foils of the present invention are thermoplastic foils, e.g. PVC foils.

On top of the printed foil, a transparent wear layer may be applied in said top layer. Said wear layer preferably comprises the same thermoplastic material as said foil, e.g. in the case of a PVC printed foil, PVC as well is used in said wear layer.

The foils of the present invention may thus be applied in so-called SPC (Solid or Stone Plastic Composite), WPC (Waterproof or Wood Plastic Composite) or LVT (Luxury Vinyl Tile) panels.

The inventor has noted that foils for providing the base foil of a decorative printed foil may lack uniformity, which in itself may lead to printing defects, or to different renditions of colors depending on the position of the printed pattern on said foil.

### SUMMARY

The present invention in the first place aims at alternative printable foils, wherein in accordance with preferred embodiments solutions are offered for one or more of the problems associated with the prior art. With this aim, the present invention, according to its first independent aspect, relates to a thermoplastic foil comprising a first main surface for carrying a decorative print, with as a characteristic that a second main surface of said foil opposite to said first main surface is provided with embossments. The inventor has surprisingly found that an embossment may be used to deal with potential irregularities or lack of uniformity of the foil. The inventors have found that a more constant rendition of colors may be obtained regardless of such irregularities. The embossments on said second main surface may compensate the irregularities in the foil so that during the printing operation the color development results similar to that expectable with a more uniform base foil.

The embossments can have a maximum depth of 10 μm or less, or 2.5 um or less. The inventors have found that below said values, the irregularity compensation effect can be enhanced. The maximum depths of the embossments can be 0.5 μm or more, for example 1 μm or more.

In the most important embodiment of the invention, said embossments can create a rugosity over the majority of said second main surface. Within the context of the present invention with rugosity said embossments are in the form of a pattern of peaks and excavation, wherein said pattern is irregular and doesn't follow a predetermined design. The inventors have found that thanks to the embossments being in the form of a rugosity, the irregularities in the foil can be better compensated. Preferably, said rugosity can show an Ra value of 10 μm Ra or less, preferably an Ra value of 2.5 μm or less. It is noted that Ra is the average, or arithmetic average of profile height deviations from the mean line. It is noted that according to a deviant and less interesting embodiment, it is possible that said embossments follow a predetermined pattern. In some embodiment the Ra value of such rugosity can be 0.5 μm or more, for example 1 μm or more.

In the most preferred embodiment of the invention, said embossments are substantially uniform over the majority of said second main surface. In this way, the compensation effect can solve issues caused by irregularities on the majority of the main surface of the foil.

It is noted that if in the preferred embodiment the embossments are formed in the second main surface of the foil, it is not excluded that in alternative embodiments the embossments, as described above, aren't made in the first main surface of the foil and/or are made in both the first and the second main surfaces of the foil.

The foil according to the invention is preferably made of a thermoplastic polymeric material. The most preferred example of thermoplastic polymeric material for the invention is polyvinylchloride (PVC). Alternatively, the foil can be made of polypropylene (PP), polyethylene (PE) or polyethylene terephthalate (PET).

Preferably the foil can have a thickness below 100 μm, more preferably below 85 μm. The foil can have a thickness above 50 μm, more preferably above 60 μm. In the preferred example the thickness of the foil can be 70 μm. it is noted that within the context of the invention the value of the thickness of the foil is meant the average value of the thickness of the foil.

The foil can comprise one or more additives like plasticizers, colorants, fillers and/or stabilizers.

Stabilizers are substances that can limit the degradation of the thermoplastic material when subjected to heat. Stabilizers can be solid or liquid. The main example of liquid stabilizers are tin-based stabilizers (Sn-based). Liquid stabilizers have the advantage of distributing uniformly within the thermoplastic material forming the foil, but being tin-based (tin is a heavy metal) their use should be limited to prevent toxicity and environmental issues. Solid stabilizers are mainly Ca/Zn stabilizers. Ca/Zn stabilizers have the advantage over liquid stabilizers to limit the toxicity and the environmental impact of their use, but on the other hand it is more difficult to obtain a homogenous distribution of the stabilizer in the thermoplastic material thereby causing irregularities in the foil. Undesired agglomerations of Ca/Zn stabilizer may lead to differences in color rendition. It is noted that irregularities may especially be available in foils that contain Ca/Zn stabilizer, for example more than 0.1 phr Ca/Zn Stabilizer, or even more than 1 phr. Therefore, the invention according to its independent aspect is of a particular relevance when the foil contains Ca/Zn stabilizers in an amount above 0.1 phr, more preferably above 1 phr.

In the preferred embodiment, the foil is uniformly colored. Preferably, the color of the foils is white as with this color the foil could be adapted for being printed with a large variety of décors. In some special embodiments, the foil can be colored of a color selected to reduce the amount of ink for developing a specific kind of décor, for example a wood décor.

A second independent aspect of the invention can relate to a method for manufacturing a foil according to the first independent aspect. Said method can comprise at least a first step of forming said foil, for example by means of calendering or extrusion, and a second step of forming said embossments on at least one of the first main surface and the second main surface. Said step of forming the embossments can preferably formed by means of an embossing roller. Alternatively, the embossments can be formed by means of electron beam radiation or plasma treatment.

It is noted that the invention can also relate to a printed foil based on the foil of the first independent aspect as well and comprising one or more printed pattern at least on the first main surface of the foil. The invention can also relate to a method for printing decorative foils involving printing one or more printed patterns on a foil of the first independent aspect.

According to the invention, the printed pattern is obtained via inkjet printing.

Preferably, the printed pattern can be formed by pigment containing inks rather than dye containing inks.

In some embodiments the inks for forming the printed pattern can be UV inks. In alternative embodiments the inks can be water-based inks. Water-based inks have the advantage of providing a reduced negative impact during lamination of a wear layer, preferably formed by a thermoplastic material, whereas UV inks can form a film on the main surface of the foil thereby negatively impacting on said lamination. In case of UV inks, lamination can be improved by interposition of an adhesion promoting layer between the printed foil and the wear layer. On the other hand, water-based inks require immediate drying for fixing the ink and reducing ink bleeding. Immediate drying involves heating of the at least the printed first main surface of the foil, for example by means of hot air or by means of IR or microwave radiation.

In some embodiments printed foil can comprise an ink receiver layer on the first main surface, so that the ink for forming the printed décor is jetted on the ink receiver layer.

Said printing operation can be a single pass printing operation or a multi-pass printing operation. In both cases, the printing operation is part of a roll-to-roll process wherein the foil is unwound from a roll, printed upon and wound up again in a roll. The available embossments are further interesting for the performance of the foil when wound up on a roll. The embossments prevent sticking, even at elevated temperatures, for example when the foil is at 70° C. for 1 hour or more. In the case of a printed foil, smearing of the ink due to the wounding can also be minimized.

It is noted that the invention can also relate to a roll of foil of the first independent aspect or to a roll of printed foil.

As already mentioned above, the foils of the invention are particularly of interest for forming printed foils for decorative panels. Said decorative panels are preferably formed in a method involving laminating said the printed foil on a substrate. Said lamination can be performed by means of gluing the foil on the substrate and/or by means of thermal lamination. Preferably, in the method for manufacturing the decorative panel the printed foil can be laminated between the substrate and a wear layer.

The wear layer can be a thermoplastic foil, preferably transparent, for example made of PVC. For example, the substrate may comprise polyvinylchloride (PVC) or another thermoplastic material, such as polypropylene (PP) and/or polyethylene (PE), and/or may comprise polyurethane (PU). As a filler material in each of these materials chalk, limestone, talc or other inorganic materials may be applied, as well as organic materials such as rice husk and/or wood particles and/or bamboo particles.

### BRIEF DESCRIPTION OF THE DRAWINGS

With the intention of better showing the characteristics of the invention, in the following, as an example without any limitative character, several preferred forms of embodiments are described with reference to the accompanying drawings, wherein:

FIG. 1 shows an enlarged cross section of a foil according to the invention;

FIG. 2 is a enlarged view of detail F2 of FIG. 1;

FIG. 3 schematically shows an upper view of a roll of decorative printed foil based on the foil of FIG. 1; and

FIG. 4 schematically shows some steps in a method for manufacturing a decorative printed foil starting from the foil of FIG. 1 and for manufacturing a decorative panel using said decorative printed foil.

### DESCRIPTION OF NON-LIMITING EMBODIMENTS

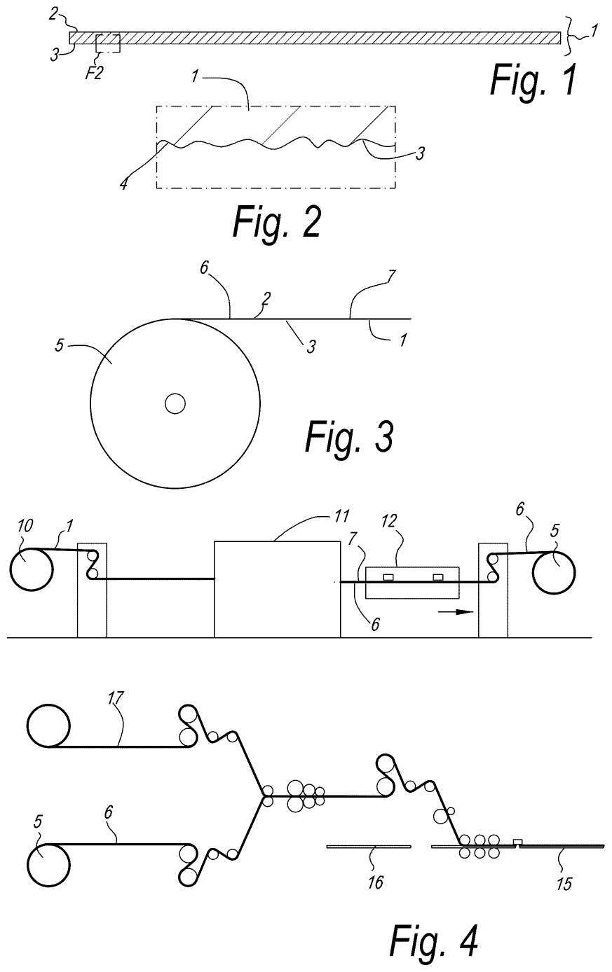

FIG. 1 shows a cross section of a foil 1 according to the first independent aspect of the invention. The foil 1 is made of PVC and comprises more than 1 phr Ca/Zn stabilizers. The foil 1 comprises a first main surface 2 and an opposite second main surface 3. The foil 1 has a thickness of 70 μm.

As shown from enlarged view of FIG. 2, the foil 1 comprises embossments 4 on said second main surface 3 adapted to compensate irregularities mainly caused by the presence of the stabilizer. The embossments 4 are in the form a rugosity uniformly distributed on the second main surface 3 having an Ra value between 0.5 and 2.5 μm.

FIG. 3 shows a roll 5 of a printed foil 6 made by the foil 1 of FIG. 1 and having a printed pattern 7 on its first main surface 2.

FIG. 4 shows some steps in a method for printing on the foil 1. The method is a roll-to-roll method wherein the foil 1 is unwound from a first roll 10 and fed to an inkjet printer 11, printed upon and then wound up again in a second roll 5 of printed foil 6. In the example the printer 11 is a single pass printer configured for printing with water-based inks. An IR drying device 12 is disposed downstream the printer 11 to immediately dry the inks after printing.

As shown by FIG. 4 the printed foil 6 is subsequently used in a method for manufacturing decorative panel 15, for example floor panels, wherein the printed foil 6 is unwound from the roll 5 and thermal laminated in a sandwich between a substrate 16, for example a PVC board, a wear layer 17, preferably a transparent PVC foil.

The present invention is in no way limited to the hereinabove described embodiments, but such foil, printed foil, roll, and method can be performed in different ways. may be realized according to different variants without leaving the scope of the present invention.

Further, as is clear from the content of the description, the present invention relates to one or more of the items as listed below:
1. A foil for providing the base foil of a decorative printed foil, wherein said foil is a plastic foil comprising a first main surface for carrying a decorative print, and a second main surface of said foil opposite to said first main surface wherein at least one between said first and second main surface is provided with embossments.
2. The foil according to item 1, wherein said embossment is provided in said second main surface.
3. The foil according to item 1 or 2, wherein said embossment is provided in said first main surface.
4. The foil according to any of the preceding items, being made of a thermoplastic material.
5. The foil according to item 4, being made of PVC.
6. The foil according to item 4 or 5, comprising one or more additives, preferably selected form the group comprising: plasticizers, stabilizers, colorant, fillers.
7. The foil according to any of items from 4 to 6, comprising a stabilizer.
8. The foil according to item 6 or 7, wherein said stabilizer is a solid stabilizer.
9. The foil according to item 8, wherein said stabilizer comprises Ca/Zn stabilizer.
10. The foil according to item 9, wherein said Ca/Zn stabilizers is present in an amount above 0.1 phr, more preferably above 1 phr.
11. The foil according to any of the preceding items, wherein said embossments have a maximum depth of 10 micrometer or less, or 2.5 micrometer or less.
12. The foil according to any of the preceding items, wherein the maximum depths of the embossments can be 0.5 μm or more, for example 1 μm or more.
13. The foil according to any of the preceding items, wherein said embossments create a rugosity over the majority of said first and/or second main surface.
14. The foil according to item 13, wherein said rugosity has an Ra value of 10 μm Ra or less.
15. The foil according to item 13 or 14, wherein said rugosity has an Ra value of 0.5 μm Ra or more.
16. The foil according to any of the preceding items, wherein said embossments are substantially uniform over the majority of said first and/or second main surface.
17. The foil according to any of the preceding items, having a thickness below 100 μm, more preferably below 85 μm.
18. The foil according to any of the preceding items, having a thickness above 60 μm.
19. The foil according to any of the preceding items, having a thickness of 70 μm
20. The foil according to any of the preceding items, wherein said foil has a uniform colour, preferably is white or whitish.
21. A decorative printed foil comprising a foil according to any of the preceding items, and a printed pattern applied to said first main surface.
22. The decorative printed foil according to item 21, wherein said printed pattern is formed by means of pigment containing inks.
23. The decorative printed foil according to item 22, wherein said inks are water-based.
24. The decorative printed foil according to any of items from 21 to 23, wherein said foil has a color being selected to limit the dry weight of ink forming the pattern.
25. The decorative printed foil according to any of items from 21 to 24, wherein said pattern is a wood or stone imitating pattern.
26. A roll of foil according to any of items 1 to 20, or of decorative printed foil according to any of items 20 to 25.
27. The roll according to item 27, wherein the outer surface of said roll is formed by a portion of said first main surface and/or a portion of said printed pattern.
28. Use of the decorative printed foil of any of the items from 21 to 25 in a method for manufacturing a decorative panel, preferably wherein said decorative printed foil is laminated on a substrate being formed of a thermoplastic material, for example being made of PVC.
29. Use of decorative printed foil according to item 28, wherein said decorative printed foil is sandwiched between said substrate and a wear layer, preferably said wear layer being formed of a thermoplastic foil.
30. A method for manufacturing a foil according to any of items 1 to 20, comprising the steps of:
forming said foil, preferably by means of extrusion and/or calandering;
forming said embossments, wherein said embossments are preferably formed by means of an engraved roller, electron beam radiation, laser engraving, plasma treatment.
31. A method for manufacturing a decorative printed foil according to any of items 21 and 25, wherein the method comprises the steps of:
providing said a foil according to any of items from 1 to 20;
printing a decorative pattern on the first main surface of the foil by means of an inkjet printer; preferably wherein said method comprises one or more of the following characteristics:
said printer is a single-pass or a multi-pass printer;
said printer is adapted to print using water-based inks and/or UV based inks;
said printer is configured for immediately drying and/or cure said inks during and/or after jetting;
said printer is a roll-to-roll printer wherein a foils unwound from a roll, printed upon and wound up again a roll.

1. A foil for providing base foil of a decorative printed foil, the foil comprising:
a first main surface for carrying a decorative print; and
a second main surface opposite to the first main surface;
wherein the foil is a plastic foil:
wherein at least one of the first and the second main surfaces is provided with embossments.

2. The foil according to claim 1, wherein the embossments are provided in the second main surface.

3. The foil according to claim 1, wherein the embossments are provided in the first main surface.

4. The foil according to claim 1, being made of a thermoplastic material.

5. The foil according to claim 4, being made of PVC.

6. The foil according to claim 4, comprising a stabilizer.

7. The foil according to claim 6, wherein the stabilizer is a solid stabilizer.

8. The foil according to claim 7, wherein the stabilizer comprises Ca/Zn stabilizer.

9. The foil according to claim 8, wherein the Ca/Zn stabilizer is present in an amount above 0.1 phr.

10. The foil according to claim 1, wherein the embossments have a maximum depth of 10 micrometer or less.

11. The foil according to any of the claim 1, wherein the maximum depths of the embossments 0.5 μm or more.

12. The foil according to claim 1, wherein the embossments create a rugosity over the majority of the first main surface and/or the second main surface.

13. The foil according to claim 12, wherein the rugosity has an Ra value of 10 μm Ra or less.

14. The foil according to claim 12, wherein the rugosity has an Ra value of 0.5 μm Ra or more.

15. The foil according to claim 1, wherein the embossments are substantially uniform over the majority of the first main surface, the second main surface, or the first and the second main,

16. The foil according to claim 1, having a thickness below 100 μm.

17. The foil according to claim 1, wherein the foil has a uniform colour.

18. A decorative printed foil comprising:
a foil according to claim 1; and
a printed pattern applied to the first main surface.

19. A roll of foil according to any of claim 1.

20. A roll of decorative printed foil according to claim 18.
